(19) United States
(12) Patent Application Publication
(10) Pub. No.: US 2014/0218294 A1
(43) Pub. Date: Aug. 7, 2014

(54) METHOD FOR REMOTE CONTROL TO INPUT CHARACTERS TO DISPLAY DEVICE

(71) Applicant: SHENZHEN SKYWORTH-RGB ELECTRONICS CO. LTD., Shenzhen (CN)

(72) Inventors: Zhi-Guo Wang, Shenzhen (CN); Xian-Hui Zeng, Shenzhen (CN); Jia Liu, Ning An (CN); Ming Chen, Shenzhen (CN); Wei-Long Lv, Shenzhen (CN)

(73) Assignee: SHENZHEN SKYWORTH-RGB ELECTRONICS CO. LTD., Shenzhen (CN)

(21) Appl. No.: 14/171,164

(22) Filed: Feb. 3, 2014

(30) Foreign Application Priority Data
Feb. 5, 2013 (CN) 201310046013.8

(51) Int. Cl. G06F 3/0354

(52) U.S. Cl. CPC G06F 3/0354
USPC 345/160

(57) ABSTRACT

In one aspect of the invention, a method for a remote control to input characters to a display device includes: in response to a character input request sent by a remote control, displaying an input box and a soft keyboard, where the soft keyboard includes a plurality of preset single characters or strings, and each string at most includes four characters; in response to a position movement instruction sent by a button on the remote control, moving a cursor to a target character, where buttons on the remote control include arrow buttons and an Ok button; and in response to an input confirmation instruction sent by a button on the remote control, inputting the target character to the input box.

### CROSS-REFERENCE TO RELATED APPLICATION

This application claims the priority to Chinese Patent Application No. CN201310046013.8, filed on Feb. 5, 2013, in the State Intellectual Property Office of P.R. China, which is hereby incorporated herein in its entirety by reference.

### FIELD OF THE INVENTION

The invention relates generally to the field of communications, and more particularly to a method for a remote control to input characters to a display device.

### BACKGROUND OF THE INVENTION

As content ends get rich and Internet technologies develop, how to use a remote control to rapidly input a character to a television is urgently desired.

As shown in FIGS. 1 and 2, in a conventional input method, numeric keys 1 to 9 on the remote control are multiplexed. For example, in order to input a Chinese character, e.g., “ [symbol] ”, the following steps need to be performed.

Step A: A television is set to enter an interface for inputting characters.

Step B: Press in sequence a “6” button, a “4” button, the “6” button and the “4” button on a remote control, so that the television shows an interface shown in FIG. 2.

Step C: Press a Down button among arrow buttons on the remote control to move a cursor to a Chinese character display area.

Step D: Press a Right button among the arrow buttons on the remote control to move the cursor to “ [symbol] ”.

Step E: Press an Ok button on the remote control to input the character “ [symbol] ” at the cursor into an input box.

The method for a remote control to input a character to a television in the prior art has the following shortcomings.

Character inputting involves many buttons, and the distances between the involved buttons are long, which makes functional buttons of the remote control complicated and reduction of the remote control in size very difficult. In addition, during character inputting, attention needs to be shifted between the remote control and the television constantly, which likely results in visual fatigue.

Therefore, a heretofore unaddressed need exists in the art to address the aforementioned deficiencies and inadequacies.

### SUMMARY OF THE INVENTION

One of the objectives of the invention is to provide a method for a remote control to input characters to a display device, so as to decrease the number of buttons involved in character inputting, thereby reducing the size of the remote control and achieving the objective of improving user experience.

In one aspect of the invention, the method for a remote control to input characters to a display device includes the following steps.

Step a: In response to a character input request sent by a remote control, display an input box and a soft keyboard, where the soft keyboard includes a plurality of preset single characters or strings, and each string at most includes 4 characters.

Step b: In response to a position movement instruction sent by a button on the remote control, move a cursor to a target character, where buttons on the remote control include arrow buttons and an Ok button.

Step c: In response to an input confirmation instruction sent by a button on the remote control, input the target character to the input box.

The characters include English characters, pinyin characters, digit/symbol characters, five-stroke radical characters, and expression characters.

In one embodiment, Step a specifically includes the following steps.

Step a1: According to the received character input instruction, display an input box and a default soft keyboard.

Step a2: According to the received input method switch instruction, switch the default soft keyboard to a target soft keyboard.

In one embodiment, Step a2 specifically includes the following steps.

Step a21: Receive an input method switch instruction sent by a Menu button on the remote control.

Step a22: According to the received input method switch instruction, switch the default soft keyboard to a target soft keyboard.

Alternatively, Step a2 specifically includes the following steps.

Step a23: In response to a position movement instruction sent by a button on the remote control, move the cursor to an input method switch button, where the soft keyboard further includes the input method switch button.

Step a24: In response to an input method switch instruction sent by a button on the remote control, switch the default soft keyboard to a target soft keyboard.

In one embodiment, when the target soft keyboard displays a plurality of preset digit/symbol characters, Step b specifically includes the following steps.

Step b11: In response to a string selection instruction sent by an arrow button of the remote control, move the cursor to a target string.

Step b12: Receive the instruction from the remote control, and determine the type of the received instruction; when the received instruction from the remote control is a string selection confirmation instruction sent by the Ok button of the remote control, go to Step b13; when the received instruction from the remote control is an input confirmation instruction sent by an arrow button of the remote control, go to Step c; before Step b13 is performed, when the received instruction from the remote control is a full/half width switch instruction sent by an arrow button of the remote control, go to Step b16; when a return instruction is received, go to Step b17.

Step b13: Display a selection box, characters of the target string being arranged in the selection box according to a preset rule, and go to Step b12.

Step b16: Switch current half width to full width, or switch current full width to half width, and go to Step b12.

Step b17: Return to a state of the previous step.

In one embodiment, when the target soft keyboard displays a plurality of preset pinyin characters, Step b specifically includes the following steps.

Step b21: In response to a string selection instruction sent by an arrow button of the remote control, move the cursor to a target string.

Step b22: Receive the instruction from the remote control, and determine the type of the received instruction; when the received instruction from the remote control is a string selection confirmation instruction sent by the Ok button of the remote control, go to Step b23; after Step b23 is performed, when the received instruction from the remote control is a string selection instruction sent by an arrow button of the remote control, go to Step b24; after Step b23 is performed, when the received instruction from the remote control is a Chinese character selection instruction sent by an arrow button of the remote control, go to Step b25; when a return instruction is received, go to Step b26.

Step b23: According to a preset character input mapping table, display a candidate Chinese character table corresponding to the target string or a combination of the target strings, and go to Step b22.

Step b24: Move the cursor to the target string, and go to Step b22.

Step b25: Move the cursor to a target Chinese character, and go to Step c.

b26: Return to a state of the previous step.

In one embodiment, the character input mapping tables include a single character input mapping table and a phrase input mapping table.

In one embodiment, when the target soft keyboard displays a plurality of preset English characters, Step b specifically includes the following steps.

Step b31: In response to a string selection instruction sent by an arrow button of the remote control, move the cursor to a target string.

Step b32: Receive the instruction from the remote control, and determine the type of the received instruction; when the received instruction from the remote control is a string selection confirmation instruction sent by the Ok button of the remote control, go to Step b33; after Step b33 is performed, when the received instruction from the remote control is a character confirmation instruction sent by the Ok button of the remote control, go to Step b35; after Step b35 is performed, when the received instruction from the remote control is an English selection instruction sent by an arrow button of the remote control, execute Step b36; before Step b33 is performed, when the received instruction from the remote control is an upper/lower case switch instruction sent by an arrow button of the remote control, execute Step b37; when a return instruction is received, execute Step b38.

Step b33: Display a selection box, characters of the target string being arranged in the selection box according to a preset rule, and go to Step b32.

Step b35: Input the target character to a pre-selection box, and according to a preset character input mapping table, display a candidate English character table corresponding to the target character or a combination of the target characters, and go to Step b32.

Step b36: Move the cursor to a target English character, and go to Step c.

Step b37: Switch current upper case to lower case, or switch current lower case to upper case, and go to Step b32.

Step b38: Return to a state of the previous step.

In one embodiment, the input box is multiplexed to be the pre-selection box.

In one embodiment, the method for a remote control to input characters to a display device further includes the following steps.

Step d1: In response to a position switch instruction sent by a button on the remote control, move the cursor to a delete button, where the soft keyboard further includes the delete button.

Step d2: In response to a delete character instruction sent by a button on the remote control, delete a character already input into the input box.

In another aspect, the invention relates to a remote control configured to perform the above-disclosed method for inputting characters to a display device.

In one embodiment, the remote control is a shuttle remote control.

In yet another aspect, the invention relates to a non-transitory computer-readable medium storing instructions which, when executed by one or more processors, cause a remote control to perform the above-disclosed method for inputting characters to a display device.

In the method for a remote control to input characters to a display device provided by the invention, in response to a character input request sent by a remote control, an input box and a soft keyboard are displayed. The soft keyboard includes a plurality of preset strings, and each string at most includes 4 characters. In this case, character inputting may be performed only through arrow buttons and an Ok button on the remote control. When a position movement instruction sent by an arrow button on the remote control is received, a cursor moves until reaching a target character. When an input confirmation instruction sent by the Ok button on the remote control is received, the target character at the cursor is input to the input box, thereby completing the character inputting. According to the invention, the soft keyboard is adopted, and the number of function buttons on the remote control can be decreased, thereby achieving the objective of decreasing the size of the remote control used by the invention. Meanwhile, in the invention, character inputting only involves the arrow buttons and the Ok button, not only the distance between the required buttons is shortened, and a character inputting speed is improved, but also shifting of attention between the remote control and a television is avoided, so as to alleviate visual fatigue incurred by character inputting, and eliminate input errors, thereby greatly improving user experience.

These and other aspects of the invention will become apparent from the following description of the preferred embodiment taken in conjunction with the following drawings, although variations and modifications therein may be effected without departing from the spirit and scope of the novel concepts of the invention.

### BRIEF DESCRIPTION OF THE DRAWINGS

The accompanying drawings illustrate one or more embodiments of the disclosure and together with the written description, serve to explain the principles of the disclosure. Wherever possible, the same reference numbers are used throughout the drawings to refer to the same or like elements of an embodiment.

FIG. 1 is a schematic view of a remote control suitable for a method for a remote control to input characters to a display device in the prior art.

FIG. 2 is a schematic view of a state of an input box and a soft keyboard in the method for a remote control to input characters to a display device in the prior art.

FIG. 3 is a schematic flow chart of a first embodiment of a method for a remote control to input characters to a display device according to the invention.

FIG. 4 is a schematic view of a remote control suitable for the method for a remote control to input characters to a display device shown in FIG. 3.

FIG. 5 is a schematic view of a first state of an input box and a soft keyboard in the method for a remote control to input characters to a display device shown in FIG. 3.

FIG. 6 is a schematic flow chart of Step a in the method for a remote control to input characters to a display device shown in FIG. 3.

FIG. 7 is a schematic flow chart of a first embodiment of Step a2 shown in FIG. 6.

FIG. 8 is a schematic flow chart of a second embodiment of Step a2 shown in FIG. 6.

FIG. 9 is a schematic view of a second state of an input box and a soft keyboard in the method for a remote control to input characters to a display device shown in FIG. 3.

FIG. 10 is a schematic flow chart of a first embodiment of Step b in the method for a remote control to input characters to a display device shown in FIG. 3.

FIG. 11 is a schematic flow chart of a second embodiment of Step b in the method for a remote control to input characters to a display device shown in FIG. 3.

FIG. 12 is a schematic view of a state of a soft keyboard shown in FIG. 5 after a string “abcd” is selected.

FIG. 13 is a schematic view of a state of the soft keyboard shown in FIG. 5 after the string “abcd” and the string “abcd” are selected.

FIG. 14 is a schematic view of a state of the soft keyboard shown in FIG. 5 after the string “abcd” and the string “qrst” are successively selected.

FIG. 15 is a schematic view of a third state of an input box and a soft keyboard in the method for a remote control to input characters to a display device shown in FIG. 3.

FIG. 16 is a schematic flow chart of a third embodiment of Step b in the method for a remote control to input characters to a display device shown in FIG. 3.

FIG. 17 is a schematic view of a state of a soft keyboard shown in FIG. 15 after a string “abcd” is selected.

FIG. 18 is a schematic view of a state of the soft keyboard shown in FIG. 15 after a character “b” is input. and

FIG. 19 is a schematic flow chart of a second embodiment of the method for a remote control to input characters to a display device according to the invention.

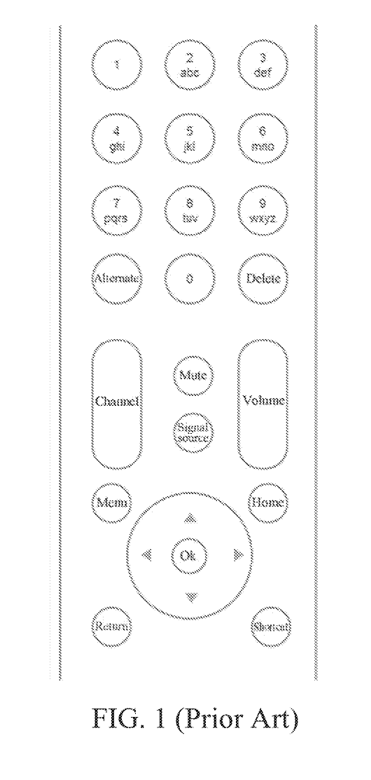

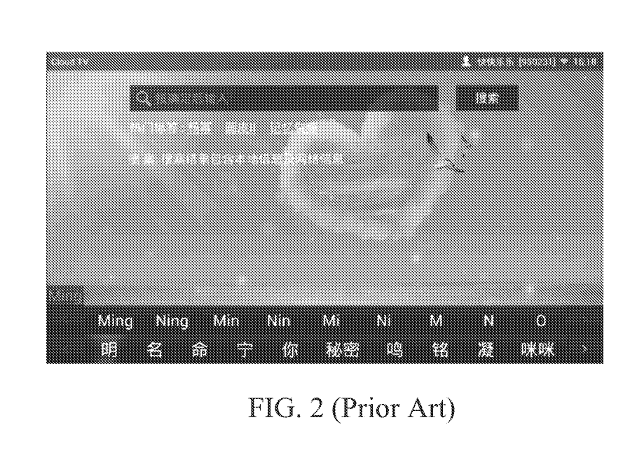

### DETAILED DESCRIPTION OF THE INVENTION

The invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terms used in this specification generally have their ordinary meanings in the art, within the context of the invention, and in the specific context where each term is used. Certain terms that are configured to describe the invention are discussed below, or elsewhere in the specification, to provide additional guidance to the practitioner regarding the description of the invention. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the invention or of any exemplified term. Likewise, the invention is not limited to various embodiments given in this specification.

It will be understood that, although the terms first, second, third etc. may be used herein to describe various elements, components, regions, layers and/or sections, these elements, components, regions, layers and/or sections should not be limited by these terms. These terms are only configured to distinguish one element, component, region, layer or section from another element, component, region, layer or section. Thus, a first element, component, region, layer or section discussed below could be termed a second element, component, region, layer or section without departing from the teachings of the disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, or “includes” and/or “including” or “has” and/or “having” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the invention, and will not be interpreted in an idealized or overly formal sense unless expressly so defined herein.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the terms “comprising,” “including,” “having,” “containing,” “involving,” and the like are to be understood to be open-ended, i.e., to mean including but not limited to.

As used herein, the phrase “at least one of A, B, and C” should be construed to mean a logical (A or B or C), using a non-exclusive logical OR. It should be understood that one or more steps within a method may be executed in different order (or concurrently) without altering the principles of the invention.

As used herein, the term “module” may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The term “code”, as used herein, may include software, firmware, and/or microcode, and may refer to programs, routines, functions, classes, and/or objects. The term “shared”, as used herein, means that some or all code from multiple modules may be executed using a single (shared) processor. In addition, some or all code from multiple modules may be stored by a single (shared) memory. The term “group”, as used herein, means that some or all code from a single module may be executed using a group of processors. In addition, some or all code from a single module may be stored using a group of memories.

The description will be made as to the embodiments of the invention in conjunction with the accompanying drawings in FIGS. 3-19. It should be understood that specific embodiments described herein are merely used for explaining the invention, but are not intended to limit the invention. In accordance with the purposes of this disclosure, as embodied and broadly described herein, this invention, in one aspect, relates to a method for a remote control to input characters to a display device.

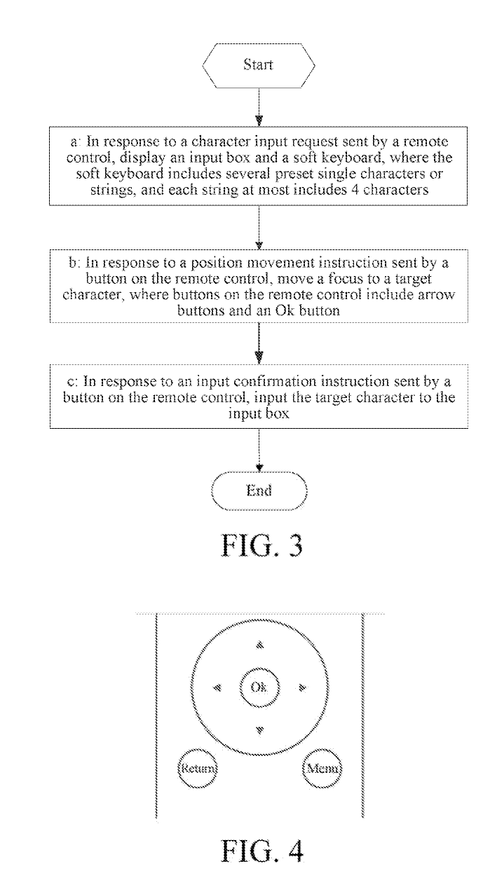

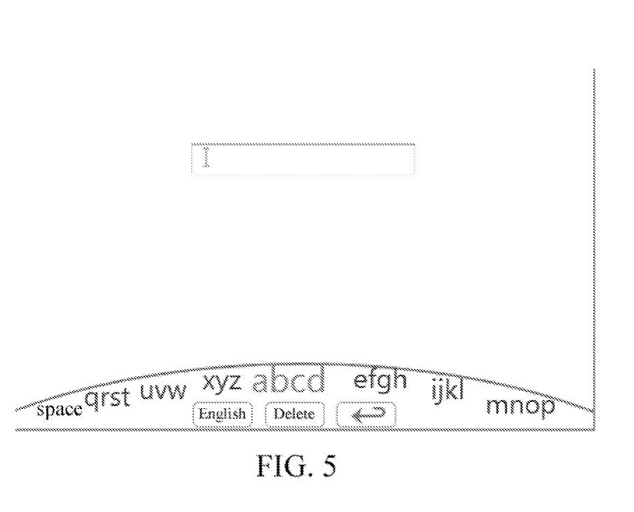

In one embodiment, a method for a remote control to input characters to a display device is shown in FIGS. 3-5. FIG. 3 is a schematic flow chart of a first embodiment of the method for a remote control to input characters to a display device according to the invention. FIG. 4 is a schematic view of a remote control suitable for the method for a remote control to input characters to a display device shown in FIG. 3. FIG. 5 is a schematic view of a first state of an input box and a soft keyboard in the method for a remote control to input characters to a display device shown in FIG. 3. In this embodiment, the method for a remote control to input characters to a display device includes the following steps.

Step a: In response to a character input request sent by a remote control, display an input box and a soft keyboard, where the soft keyboard includes a plurality of preset single characters or strings, and each string at most includes four characters.

When a character needs to be input to a display device through the remote control, the remote control sends the character input request, and upon receiving the character input request, the display device displays the input box and the soft keyboard. The soft keyboard may be designed into multiple kinds according to input modes. The input modes may include a pinyin input method, an English input mode, a digit/symbol input mode, a five-stroke input mode, a stroke input mode, and an expression input mode. When the input mode is the pinyin input mode, the soft keyboard includes seven letter strings (“abcd”, “efgh”, “ijkl”, “mnop”, “qrst”, “uvw”, and “xyz”) and “space” (definitely, the “space” may not be designed, and other functional symbols may also be added), totally 8 (definitely, it is not limited to be set to 8, the number may be set according to needs, and symbols in each string may also be set according to needs). For another example, when the input mode is the digit/symbol input mode, the soft keyboard includes 3 numeric strings (“1234”, “5678”, and “90space”) and 4 symbol strings (“; : -&”, “=*/ . . . ”, “@# [symbol] %”, and “, ∘ [symbol] ”), totally 7 (definitely, it is not limited to be set to 7, the number may be set according to needs, and symbols in each string may also be set according to needs).

Step b: In response to a position movement instruction sent by a button on the remote control, move a cursor to a target character, where buttons on the remote control include arrow buttons and an Ok button.

The cursor on the display device may move according to a position movement instruction that is sent after an arrow button on the remote control is triggered. For example, after an Up, Down, Left, or Right button among the arrow buttons on the remote control is triggered, a position movement instruction is sent, so as to make the cursor move between several characters in the soft keyboard.

Step c: In response to an input confirmation instruction sent by a button on the remote control, input the target character to the input box.

When the cursor is on a certain character, the arrow buttons and the Ok button on the remote control all can input the character at the cursor into the input box. In different input modes, the arrow buttons or the Ok button on the remote control inputs the character at the cursor into the input box, which may be referred to subsequent illustration of specific embodiments.

In the method for a remote control to input characters to a display device provided by the invention, in response to the character input request sent by the remote control, the input box and the soft keyboard are displayed. The soft keyboard includes a plurality of preset single characters or strings, and each string at most includes 4 characters. In this case, character inputting may be performed only through the arrow buttons and the Ok button on the remote control. When the position movement instruction sent by the remote control is received, the cursor moves until reaching the target character. When the input confirmation instruction sent by the remote control is received, the target character at the cursor is input to the input box, thereby completing the character inputting. In contrast to the prior art, since the soft keyboard is adopted, the number of function buttons on the remote control can be decreased, so as to decrease the size of the remote control used by the invention. Meanwhile, in the invention, character inputting only involves the arrow buttons and the Ok button, not only the distance between the required buttons is shortened, and a character inputting speed is improved, but also shifting of attention between the remote control and the television is avoided, so as to alleviate visual fatigue incurred by character inputting, and eliminate input errors, thereby greatly improving user experience.

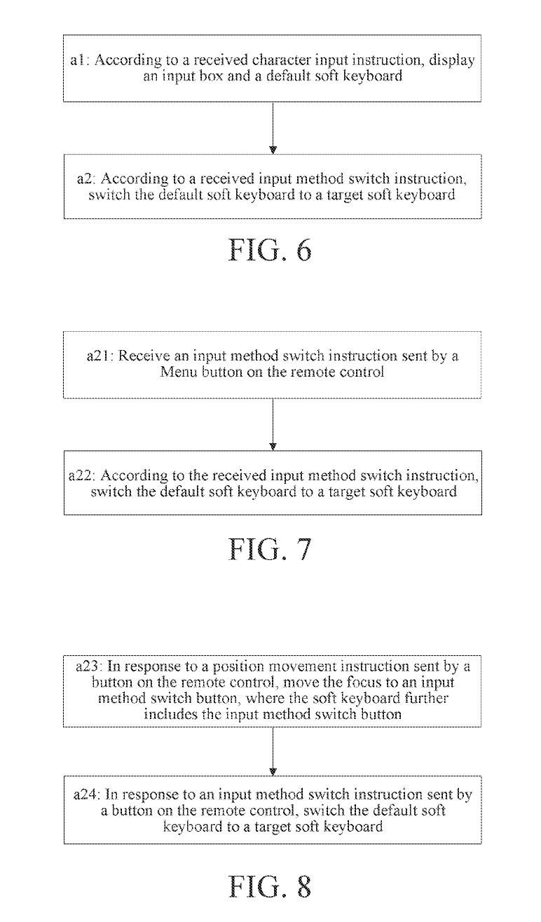

The input modes may include the pinyin input mode, the English input mode, the digit/symbol input mode, the five-stroke input mode, the stroke input mode, the expression input mode, and other shortcut character groups, and a user can select any input mode according to needs. That is to say, the soft keyboard needs to switch between pinyin characters, English characters, digit/symbol input mode, and five-stroke radical characters. FIG. 6 is a schematic flow chart of Step a in the method for a remote control to input characters to a display device shown in FIG. 3. In a specific embodiment, Step a in the method for a remote control to input characters to a display device shown in FIG. 3 includes the following specific steps.

Step a1: According to the received character input instruction, display an input box and a default soft keyboard.

Step a2: According to the received input method switch instruction, switch the default soft keyboard to a target soft keyboard.

The default soft keyboard may include pinyin characters, or English characters, or digit/symbol characters, or five-stroke radical characters, which are preset and arranged one by one. For example, the default soft keyboard is the soft keyboard corresponding to the pinyin input mode, that is, the soft keyboard displays “abcd”, “efgh”, “ijkl”, “mnop”, “qrst”, “uvw”, “xyz” and “space”. In order to input a digit or a symbol, a user sends an input method switch instruction through the remote control, and the display device, in response to the input method switch instruction, switches the current soft keyboard corresponding to the pinyin input mode to the soft keyboard corresponding to the digit/symbol input mode, that is, displays “1234”, “5678”, “90space”, “; : -&”, “=*/ . . . ”, “@# [symbol] %”, and “, ∘ [symbol] ”. Definitely the input modes in the method for a remote control to input characters to a display device according to the invention are not limited to the aforementioned manner. For example, only one input mode may exist, that is, no input method switch operation needs to be performed, and in this case, the soft keyboard includes pinyin characters, English characters, digit/symbol characters, numeric characters, symbol characters, or five-stroke radical characters, which are preset and divided into groups. In other embodiment variations, alternatively, the soft keyboard may include a combination of pinyin characters, English characters, digit/symbol characters, five-stroke radical characters, and expression characters, and other shortcut character groups, which are preset and divided into groups, and in this case no input method switch operation needs to be performed either.

FIG. 7 is a schematic flow chart of a first embodiment of Step a2 shown in FIG. 6. In the specific embodiment, Step a2 shown in FIG. 6 includes the following specific steps.

Step a21: Receive an input method switch instruction sent by a Menu button on the remote control.

Step a22: According to the received input method switch instruction, switch the default soft keyboard to a target soft keyboard.

In order to conveniently and rapidly switch the input method, the remote control is provided with a shortcut button for switching the input method. Definitely, the exiting Menu button on the remote control may be multiplexed for switching the input method.

FIG. 8 is a schematic flow chart of a second embodiment of Step a2 shown in FIG. 6. In the specific embodiment, Step a2 shown in FIG. 6 includes the following specific steps.

Step a23: In response to a position movement instruction sent by a button on the remote control, move the cursor to an input method switch button, where the soft keyboard further includes the input method switch button.

Step a24: In response to an input method switch instruction sent by a button on the remote control, switch the default soft keyboard to a target soft keyboard.

In this embodiment, during the input method switch operation, the cursor needs to be moved to the input method switch button before the input method switch operation can be performed. It should be understood that, the remote control sending the position movement instruction may be triggered through the Up, Down, Left, and Right arrow buttons, and the remote control sending the input method switch instruction may be triggered through the Ok button, and may also be designed according to use habits and intuitiveness.

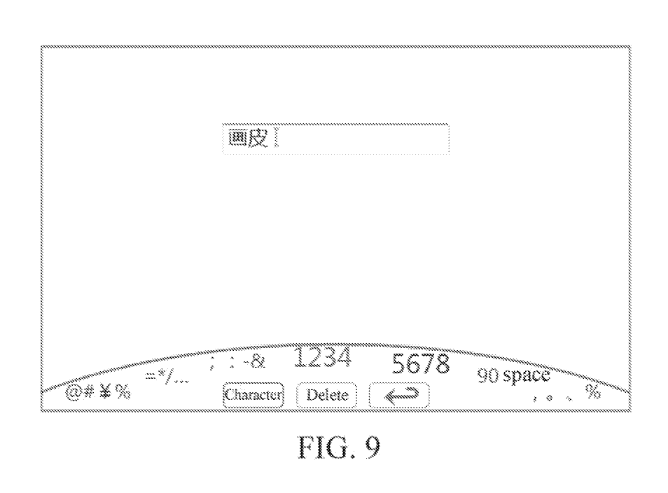

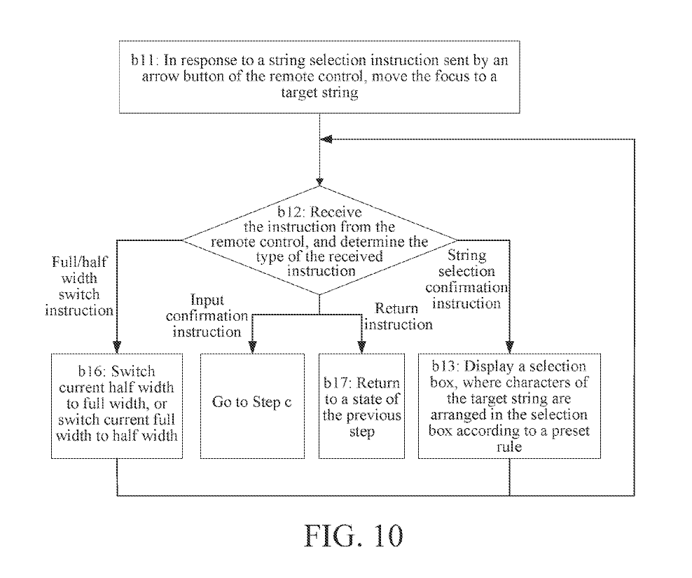

When a digit/symbol character needs to be input, the soft keyboard displays “1234”, “5678”, “90space”, “; : -&”, “=*/ . . . ”, “@# [symbol] %”, and “, ∘ [symbol] ”. The soft keyboard in this case may be referred to FIG. 9, which is a schematic view of a second state of the input box and the soft keyboard in the method for a remote control to input characters to a display device shown in FIG. 3. Also referring to FIG. 10, which shows a schematic flow chart of a first embodiment of Step b in the method for a remote control to input characters to a display device shown in FIG. 3, in this embodiment, Step b in the method for a remote control to input characters to a display device shown in FIG. 3 includes the following specific steps.

Step b11: In response to a string selection instruction sent by an arrow button of the remote control, move the cursor to a target string.

Step b12: Receive the instruction from the remote control, and determine the type of the received instruction; when the received instruction from the remote control is a string selection confirmation instruction sent by the Ok button of the remote control, go to Step b13; when the received instruction from the remote control is an input confirmation instruction sent by an arrow button of the remote control, go to Step c; before Step b13 is performed, when the received instruction from the remote control is a full/half width switch instruction sent by an arrow button of the remote control, go to Step b16; when a return instruction is received, go to Step b17.

Step b13: Display a selection box, characters of the target string being arranged in the selection box according to a preset rule, and go to Step b12.

Step b16: Switch current half width to full width, or switch current full width to half width, and go to Step b12.

Step b17: Return to a state of the previous step.

Operations performed to input a character “7” are taken as an example below to describe the embodiment of the invention.

1. The remote control sends a character input request. The display device displays an input box and a soft keyboard. In this case, the soft keyboard is as what is shown in FIG. 9.

When the current soft keyboard is not for digit/symbol characters, an input method switch operation needs to be performed.

2. The Right button of the remote control is pressed to send a position movement instruction. The cursor moves from the string “1234” to the string “5678”. It should be understood that, in this case, the cursor moves, but the string does not move; alternatively, the string moves, but the cursor does not move.

3. The Ok button on the remote control is pressed to send a string selection confirmation instruction, the string “5678” is selected, and the selection box is displayed. The string “5678” is arranged clockwise in the selection box (definitely, the string “5678” is not limited to be arranged clockwise), that is, the character “5” is located in a left portion of the selection box, the character “6” is located in an upper portion of the selection box, the character “7” is located in a right portion of the selection box, and the character “8” is located in a lower portion of the selection box.

4. The Right button of the remote control is pressed to send an input confirmation instruction, and the character “7” is input into the input box.

In specific embodiments, in order to make selection of a numeric character convenient, the arrangement of numeric characters is not limited to the aforementioned manner, and for example, a manner of regarding each character as a group may be adopted.

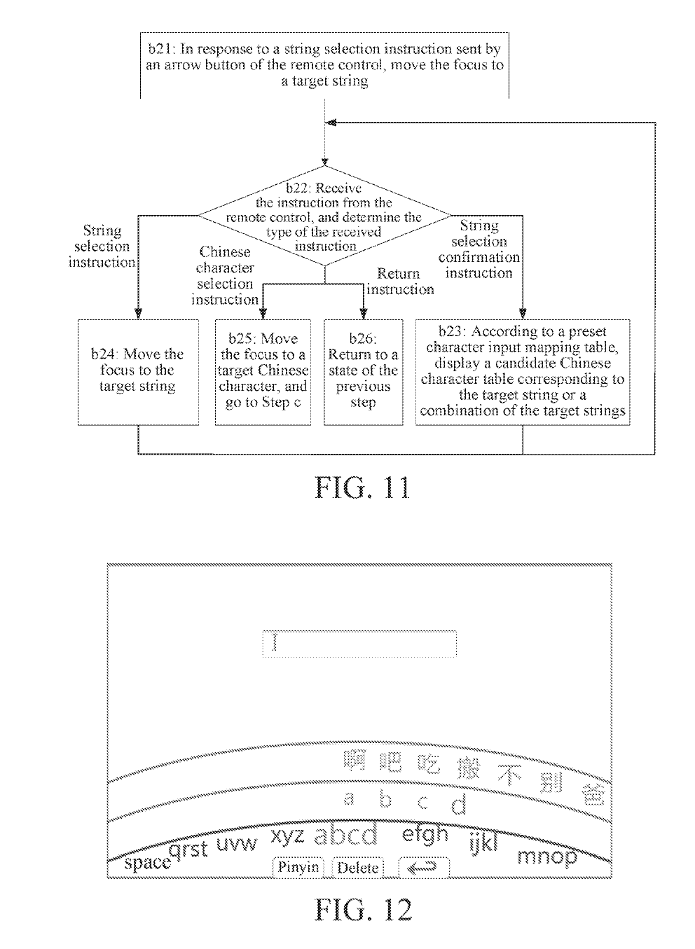

When a Chinese character needs to be input, the soft keyboard displays “abcd”, “efgh”, “ijkl”, “mnop”, “qrst”, “uvw”, “xyz” and “space”, and the soft keyboard in this case may be referred to FIG. 4 again. Also referring to FIG. 11, which shows a schematic flow chart of a second embodiment of Step b in the method for a remote control to input characters to a display device shown in FIG. 3, in this embodiment, Step b in the method for a remote control to input characters to a display device shown in FIG. 3 includes the following specific steps.

Step b21: In response to a string selection instruction sent by an arrow button of the remote control, move the cursor to a target string.

Step b22: Receive the instruction from the remote control, and determine the type of the received instruction; when the received instruction from the remote control is a string selection confirmation instruction sent by the Ok button of the remote control, go to Step b23; after Step b23 is performed, when the received instruction from the remote control is a string selection instruction sent by an arrow button of the remote control, go to Step b24; after Step b23 is performed, when the received instruction from the remote control is a Chinese character selection instruction sent by an arrow button of the remote control, go to Step b25; when a return instruction is received, go to Step b26.

Step b23: According to a preset character input mapping table, display a candidate Chinese character table corresponding to the target string or a combination of the target strings, and go to Step b22.

Step b24: Move the cursor to the target string, and go to Step b22.

Step b25: Move the cursor to a target Chinese character, and go to Step c.

Step b26: Return to a state of the previous step.

Operations performed to input a character “ [symbol] ” are taken as an example below to describe the embodiment of the invention.

1. The remote control sends a character input request. The display device displays an input box and a soft keyboard. In this case, the soft keyboard is as what is shown in FIG. 5.

When the current soft keyboard is not for pinyin characters, an input method switch operation needs to be performed.

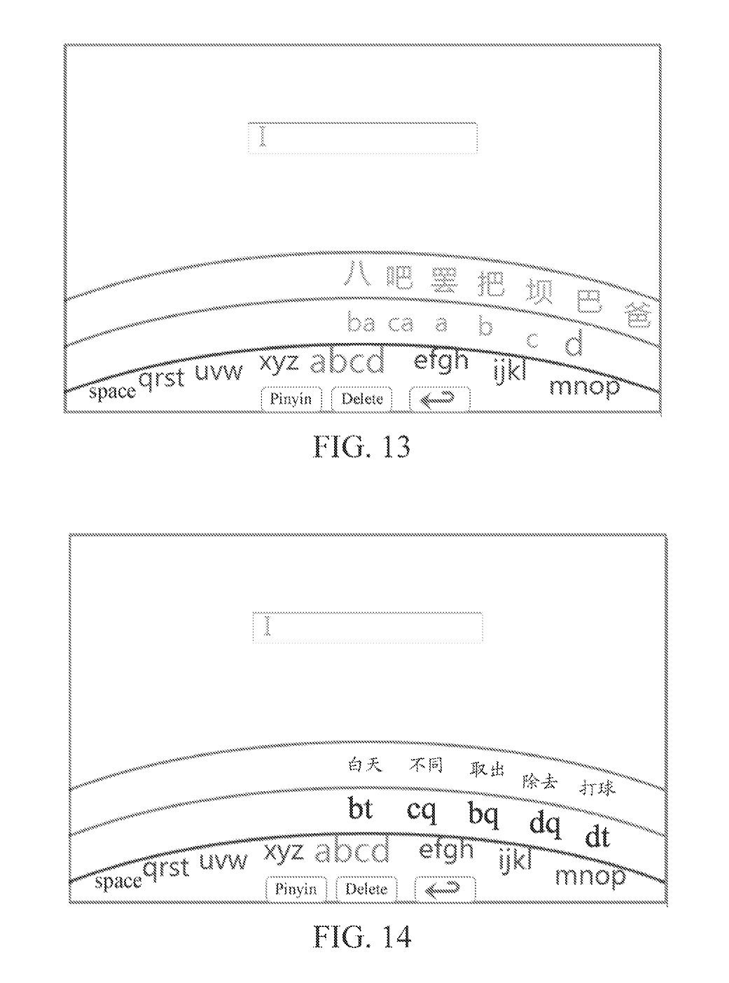

2. The Ok button of the remote control is pressed to send a string selection instruction, and according to a preset character input mapping table, a candidate Chinese character table corresponding to the string “abcd” is displayed, and for example, [symbol] , [symbol] , [symbol] , [symbol] , [symbol] , [symbol] , [symbol] , etcetera are displayed. Referring to FIG. 12, FIG. 12 is a schematic view of a state of the soft keyboard shown in FIG. 5 after the string “abcd” is selected.

Since the cursor is located on the string “abcd”, the Left button and the Right button of the remote control do not need to be pressed to send a position movement instruction to select the target string.

3. Since the character “ [symbol] ” is in the candidate Chinese character table, the Up button of the remote control is pressed to send a position movement instruction, and the cursor moves from a letter area to a Chinese character area.

4. The Right button of the remote control is pressed (it is not limited to one pressing) to send a position movement instruction, and the cursor moves to the Chinese character “ [symbol] ”.

5. The Ok button on the remote control is pressed to send an input confirmation instruction, and the Chinese character “ [symbol] ” is input into the input box. Operations performed to input a character “ [symbol] ” are further taken as an example below to describe the embodiment of the invention.

1. The remote control sends a character input request. The display device displays an input box and a soft keyboard. In this case, the soft keyboard is as what is shown in FIG. 5.

When the current soft keyboard is not for pinyin characters, an input method switch operation needs to be performed.

2. The Ok button of the remote control is pressed to send a string selection instruction, and according to a preset character input mapping table, display a candidate Chinese character table corresponding to the string “abcd”, for example, display [symbol] , [symbol] , [symbol] , [symbol] , [symbol] , [symbol] , [symbol] , etc. Referring to FIG. 12, FIG. 12 is a schematic view of a state of the soft keyboard shown in FIG. 5 after the string “abcd” is selected.

Since the cursor is located on the string “abcd”, the Left button and the Right button of the remote control do not need to be pressed to send a position movement instruction to select the target string.

3. Since the character “ [symbol] ” is not in the candidate Chinese character table, the Ok button of the remote control is pressed again to send a string selection instruction. According to the preset character input mapping table, a candidate Chinese character table corresponding to the string “abcd” and the string “abcd” is displayed, and for example, [symbol] , [symbol] , [symbol] , [symbol] , [symbol] , [symbol] , [symbol] , etcetera are displayed. Referring to FIG. 13, FIG. 13 is a schematic view of a state of the soft keyboard shown in FIG. 5 after the string “abcd” and the string “abcd” are selected.

Since the cursor is located on the string “abcd”, the Left button and the Right button of the remote control do not need to be pressed to send a position movement instruction to select the target string.

If the cursor is away from the string to be selected, the Down button of the remote control may be pressed first (or a Return button is disposed) to make the cursor return to a default position in the soft keyboard.

4. Since the character “ [symbol] ” is in the candidate Chinese character table, the Up button of the remote control is pressed to send a position movement instruction, and the cursor moves from a letter area to a Chinese character area.

5. The Ok button on the remote control is pressed to send an input confirmation instruction, and the Chinese character “ [symbol] ” is input into the input box.

Since the cursor is located on the character “ [symbol] ”, the Left button and the Right button of the remote control do not need to be pressed to send a position movement instruction to select the target Chinese character.

In order to increase input speed, during Chinese character inputting, a phrase may be input. If “ [symbol] ” needs to be input, the string “abcd” and the string “qrst” may be selected successively, and during association, phrases such as “ [symbol] ” may be displayed.

In a specific embodiment, character input mapping tables include a single character input mapping table and a phrase input mapping table, so as to be invoked during inputting of a single character and a phrase.

Operations performed to input characters “ [symbol] ” are taken as an example below to describe the embodiment of the invention.

1. The remote control sends a character input request. The display device displays an input box and a soft keyboard. In this case, the soft keyboard is as what is shown in FIG. 5.

When the current soft keyboard is not for pinyin characters, an input method switch operation needs to be performed.

2. The Ok button of the remote control is pressed to send a string selection instruction, and according to a preset character input mapping table, display a candidate Chinese character table corresponding to the string “abcd”, for example, display [symbol] , [symbol] , [symbol] , [symbol] , [symbol] , [symbol] , [symbol] , etc. Referring to FIG. 12, FIG. 12 is a schematic view of a state of the soft keyboard shown in FIG. 5 after the string “abcd” is selected.

Since the cursor is located on the string “abcd”, the Left button and the Right button of the remote control do not need to be pressed to send a position movement instruction to select the target string.

3. Since neither the character “ [symbol] ” nor the phrase “ [symbol] ” in the candidate Chinese character table (only the input of a “phrase” is taken as an example herein to illustrate this embodiment), in this case the Left button of the remote control is pressed to send a position movement instruction, and the cursor moves from the string “abcd” to the string “qrst”. It should be understood that, in this case, the cursor moves, but the string does not move; alternatively, the string moves, but the cursor does not move.

4. The Ok button of the remote control is pressed to send a string selection instruction. According to a preset character input mapping table (a phrase input mapping table), a candidate Chinese character table (a candidate Chinese phrase table) corresponding to a combination of the string “abcd” and the string “qrst” is displayed, and for example, [symbol] , [symbol] , [symbol] , [symbol] , [symbol] , etcetera are displayed. Referring to FIG. 14, FIG. 14 is a schematic view of a state of the soft keyboard shown in FIG. 5 after the string “abcd” and the string “qrst” are successively selected.

If the cursor is away from the string to be selected, the Down button of the remote control may be pressed first to make the cursor return to a default position in the soft keyboard.

5. Since the phrase “ [symbol] ” is in the candidate Chinese phrase table, the Up button of the remote control is pressed to send a position movement instruction, and the cursor moves from a letter area to a Chinese character area.

6. The Right button of the remote control is pressed (it is not limited to one pressing) to send a position movement instruction, and the cursor moves to the phrase “ [symbol] [symbol] ”.

7. The Ok button on the remote control is pressed to send an input confirmation instruction, and the phrase “ [symbol] ” is input into the input box.

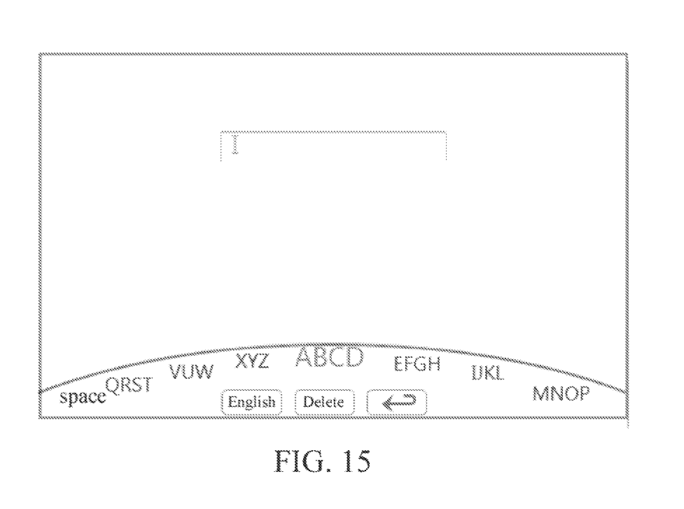

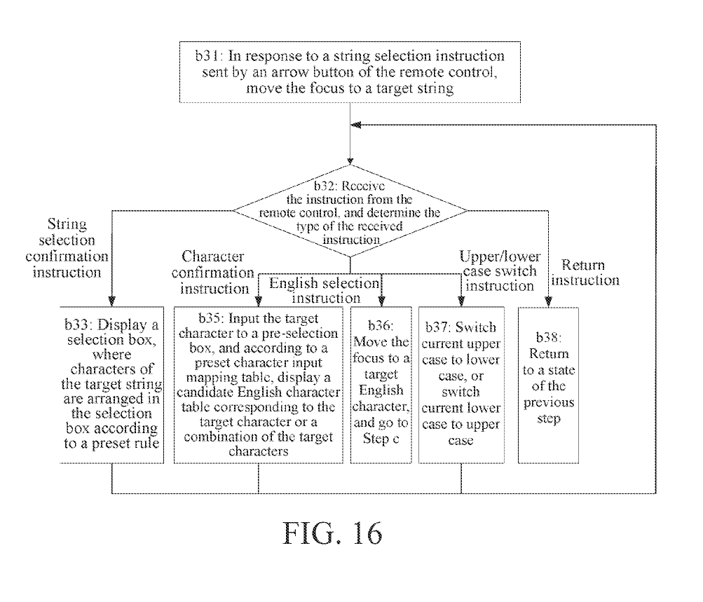

When an English character needs to be input, the soft keyboard displays “abcd”, “efgh”, “ijkl”, “mnop”, “qrst”, “uvw”, “xyz”, and “space”. The soft keyboard in this case may be referred to FIG. 15, which is a schematic view of a third state of the input box and the soft keyboard in the method for a remote control to input characters to a display device shown in FIG. 3. Also referring to FIG. 16, which shows is a schematic flow chart of a third embodiment of Step b in the method for a remote control to input characters to a display device shown in FIG. 3, in this embodiment, Step b in the method for a remote control to input characters to a display device shown in FIG. 3 includes the following specific steps.

Step b31: In response to a string selection instruction sent by an arrow button of the remote control, move the cursor to a target string.

Step b32: Receive the instruction from the remote control, and determine the type of the received instruction; when the received instruction from the remote control is a string selection confirmation instruction sent by the Ok button of the remote control, go to Step b33; after Step b33 is performed, when the received instruction from the remote control is a character confirmation instruction sent by an arrow button of the remote control, go to Step b35; after Step b35 is performed, when the received instruction from the remote control is an English selection instruction sent by an arrow button of the remote control, execute Step b36; before Step b33 is performed, when the received instruction from the remote control is an upper/lower case switch instruction sent by an arrow button of the remote control, execute Step b37; when a return instruction is received, execute Step b38.

Step b33: Display a selection box, characters of the target string being arranged in the selection box according to a preset rule, and go to Step b32.

Step b35: Input the target character to a pre-selection box, and according to a preset character input mapping table, display a candidate English character table corresponding to the target character or a combination of the target characters, and go to Step b32.

Step b36: Move the cursor to a target English character, and go to Step c.

Step b37: Switch current upper case to lower case, or switch current lower case to upper case, and go to Step b32.

Step b38: Return to a state of the previous step.

Operations performed to input characters “bag” are taken as an example below to describe the embodiment of the invention.

1. The remote control sends a character input request. The display device displays an input box and a soft keyboard. In this case, the soft keyboard is as what is shown in FIG. 15.

When the current soft keyboard is not for English characters, an input method switch operation needs to be performed.

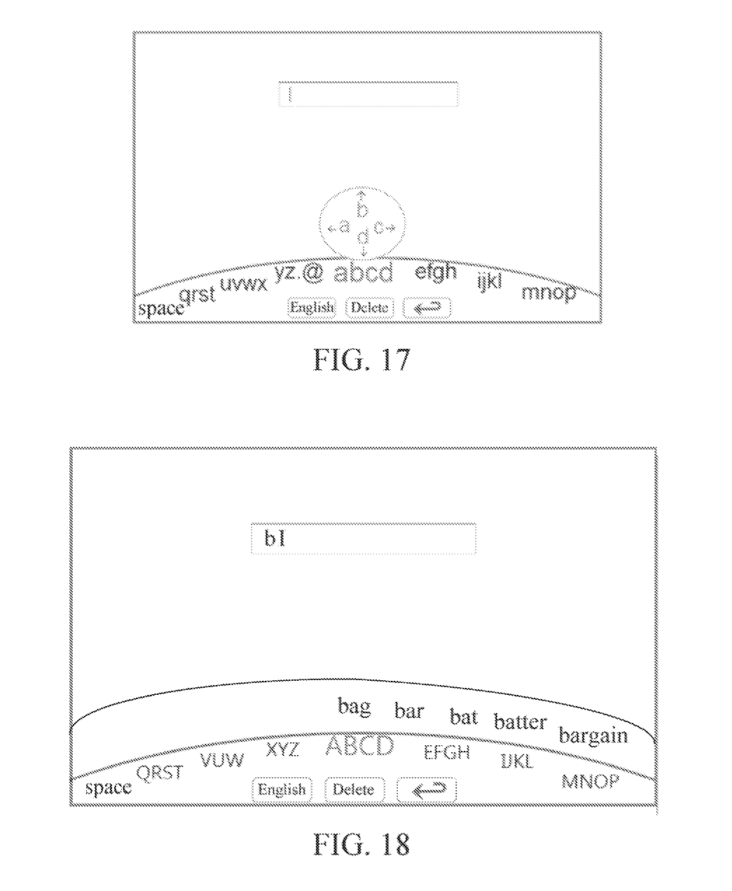

2. The Ok button on the remote control is pressed to send a string selection confirmation instruction, the string “abcd” is selected, and the selection box is displayed. The string “abcd” is arranged clockwise in the selection box (definitely, the string “abcd” is not limited to be arranged clockwise), that is, the character “a” is located in a left portion of the selection box, the character “b” is located in an upper portion of the selection box, the character “c” is located in a right portion of the selection box, and the character “d” is located in a lower portion of the selection box. At the moment, the cursor is by default located on the character “a”. At the moment, the soft keyboard may be referred to FIG. 17. FIG. 17 is a schematic view of a state of the soft keyboard shown in FIG. 15 after the string “abcd” is selected.

Since the cursor is located on the string “abcd”, the Left button and the Right button of the remote control do not need to be pressed to send a position movement instruction to select the target string.

3. The Up button of the remote control is pressed to send an input confirmation instruction, the character “b” is input into the input box, and according to a preset character input mapping table, a candidate English character table corresponding to the character “b” is displayed, and for example, bag, bar, bat, batter, bargain, etcetera are displayed. Referring to FIG. 18, FIG. 18 is a schematic view of a state of the soft keyboard shown in FIG. 15 after the character “b” is input.

4. Since the English characters “bag” are in the candidate English character table, the Up button of the remote control is pressed to send a position movement instruction, and the cursor moves from a letter area to an English character area.

Since the English characters “bag” are in the candidate English character table, the character “a” and the character “g” do not need to be input.

5. The Ok button on the remote control is pressed to send an input confirmation instruction, and the English characters “bag” are input into the input box.

The cursor falls just on the English characters “bag”, so that the Left button and the Right button of the remote control do not need to be used to send a position movement instruction.

When a five-stroke radical character needs to be input, the soft keyboard displays five-stroke radicals divided into groups. Steps for inputting a five-stroke radical are the same as the steps for pinyin inputting, and may be referred to the description of pinyin inputting, which is not repeated herein.

When an expression character needs to be input, the soft keyboard displays expressions divided into groups. Steps for expression inputting are the same as the steps for digit/symbol inputting, and may be referred to the description of digit/symbol inputting, which is not repeated herein.

In a specific embodiment, the pre-selection box is located in the soft keyboard. In a preferred embodiment, the input box may be multiplexed to be the pre-selection box, so as to simplify the design of the soft keyboard.

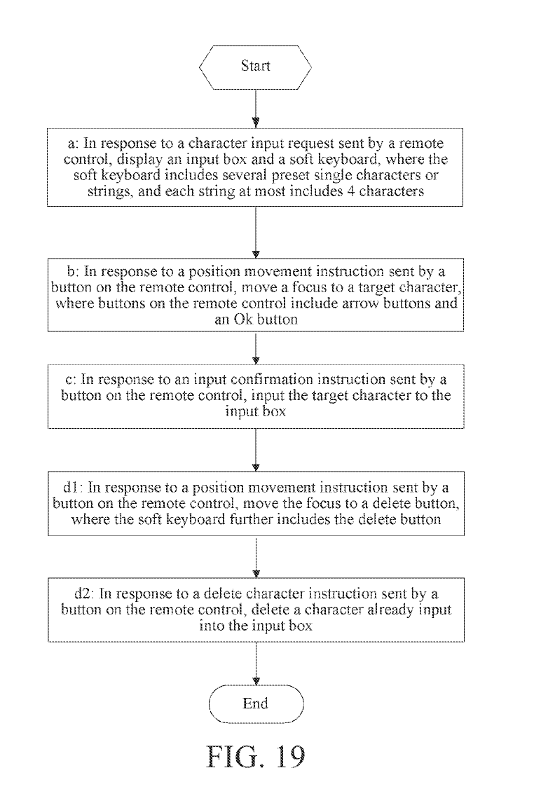

FIG. 19 is a schematic flow chart of a second embodiment of the method for a remote control to input characters to a display device according to the invention. On the basis of the embodiment shown by FIG. 3, this embodiment further includes Step d1 and Step d2. In this embodiment, the method for a remote control to input characters to a display device according to the invention includes the following steps.

Step a: In response to a character input request sent by a remote control, display an input box and a soft keyboard, where the soft keyboard includes a plurality of preset single characters or strings, and each string at most includes 4 characters.

Step b: In response to a position movement instruction sent by a button on the remote control, move a cursor to a target character, where buttons on the remote control include arrow buttons and an Ok button.

Step c: In response to an input confirmation instruction sent by a button on the remote control, input the target character to the input box.

Step d1: In response to a position movement instruction sent by a button on the remote control, move the cursor to a delete button, where the soft keyboard further includes the delete button.

Step d2: In response to a delete character instruction sent by a button on the remote control, delete a character already input into the input box.

In this embodiment, during the character delete operation, the cursor needs to be moved to the delete button before the character delete operation can be performed. It should be understood that, the remote control sending the position switch instruction may be triggered through the Up and Down buttons, and the remote control sending the delete character instruction may be triggered through the Right button, and may also be designed according to use habits and intuitiveness.

In a preferred embodiment, the remote control of the invention is a shuttle remote control, and in this case the character selection speed is higher, so as to further increase the character input speed.

In one embodiment, arrangement of characters in the soft keyboard may be designed according to needs. In one embodiment, a plurality of characters in the soft keyboard surround the input box and are evenly distributed. Alternatively, a plurality of characters in the soft keyboard is vertically evenly arranged on one side of the input box. Alternatively, a plurality of characters in the soft keyboard is horizontally evenly arranged on upper and lower sides of the input box. Alternatively, a plurality of characters in the soft keyboard are evenly distributed in a lower portion of a screen of the display device and are arranged in the shape of an arc or vertically or horizontally.

In one aspect, the invention relates to a remote control configured to perform the above-disclosed method for inputting characters to a display device. In one embodiment, the remote control is a shuttle remote control.

It should be noted that all or a part of the steps according to the embodiments of the invention is implemented by hardware or a program instructing relevant hardware. Yet another aspect of the invention provides a non-transitory computer readable storage medium which stores computer executable instructions or program codes which, when executed by one or more processors, cause a remote control to perform the above-disclosed method for inputting characters to a display device. The computer executable instructions or program codes enable one or more processors to complete various operations in the above disclosed method. The storage medium includes, but not limited to, a magnetic disk, an optical disk, a read-only memory (ROM), a random access memory (RAM), random memory (RAM), flash dive, or the likes.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the invention pertains without departing from its spirit and scope. Accordingly, the scope of the invention is defined by the appended claims rather than the foregoing description and the exemplary embodiments described therein.

What is claimed is:

1. A method for a remote control to input characters to a display device, comprising:
(a) in response to a character input request sent by a remote control, displaying an input box and a soft keyboard, wherein the soft keyboard comprises a plurality of preset single characters or strings, and wherein each string at most comprises four characters;
(b) in response to a position movement instruction sent by a button on the remote control, moving a cursor to a target character, wherein buttons on the remote control comprise arrow buttons and an Ok button; and
(c) in response to an input confirmation instruction sent by a button on the remote control, inputting the target character to the input box.
wherein the characters comprise English characters, pinyin characters, digit/symbol characters, five-stroke radical characters, and expression characters.

2. The method according to claim 1, wherein Step (a) comprises:
(a1) according to the received character input instruction, displaying the input box and a default soft keyboard; and
(a2) according to an input method switch instruction, switching the default soft keyboard to a target soft keyboard.

3. The method according to claim 2, wherein Step (a2) comprises:
(a21) receiving the input method switch instruction sent by a Menu button on the remote control; and
(a22) according to the received input method switch instruction, switching the default soft keyboard to the target soft keyboard;

4. The method according to claim 2, wherein Step (a2) comprises:
(a23) in response to the position movement instruction sent by the button on the remote control, moving the cursor to an input method switch button, wherein the soft keyboard further comprises the input method switch button; and
(a24) in response to the input method switch instruction sent by a button on the remote control, switching the default soft keyboard to the target soft keyboard.

5. The method according to claim 1, wherein when the target soft keyboard displays a plurality of preset digit/symbol characters, Step (b) comprises:
(b11) in response to a string selection instruction sent by an arrow button of the remote control, moving the cursor to a target string;
(b12) receiving the instruction from the remote control, and determining the type of the received instruction; when the received instruction from the remote control is a string selection confirmation instruction sent by the Ok button of the remote control, performing Step (b13); when the received instruction from the remote control is an input confirmation instruction sent by an arrow button of the remote control, performing Step (c); before Step (b13) is performed, when the received instruction from the remote control is a full/half width switch instruction sent by an arrow button of the remote control, performing Step (b16); when a return instruction is received, performing Step (b17);
(b13) displaying a selection box, characters of the target string being arranged in the selection box according to a preset rule, and performing Step (b12);
(b16) switching current half width to full width, or switching current full width to half width, and performing Step (b12); and
(b17) returning to a state of the previous step.

6. The method according to claim 1, wherein when the target soft keyboard displays a plurality of preset pinyin characters, Step (b) comprises:
(b21) in response to a string selection instruction sent by an arrow button of the remote control, moving the cursor to a target string;
(b22) receiving the instruction from the remote control, and determining the type of the received instruction; when the received instruction from the remote control is a string selection confirmation instruction sent by the Ok button of the remote control, performing Step (b23); after Step (b23) is performed, when the received instruction from the remote control is a string selection instruction sent by an arrow button of the remote control, performing Step (b24); after Step b23 is performed, when the received instruction from the remote control is a Chinese character selection instruction sent by an arrow button of the remote control, performing Step (b25); when a return instruction is received, performing Step (b26);
(b23) according to a preset character input mapping table, displaying a candidate Chinese character table corresponding to the target string or a combination of the target strings, and performing Step (b22);
(b24) moving the cursor to the target string, and performing Step (b22);
(b25) moving the cursor to a target Chinese character, and performing Step c; and
(b26) returning to a state of the previous step.

7. The method according to claim 6, wherein the character input mapping tables comprise a single character input mapping table and a phrase input mapping table.

8. The method according to claim 1, wherein when the target soft keyboard displays a plurality of preset English characters, Step (b) comprises:
(b31) in response to a string selection instruction sent by an arrow button of the remote control, moving the cursor to a target string;
(b32) receiving the instruction from the remote control, and determining the type of the received instruction; when the received instruction from the remote control is a string selection confirmation instruction sent by the Ok button of the remote control, performing Step (b33); after Step (b33) is performed, when the received instruction from the remote control is a character confirmation instruction sent by the Ok button of the remote control, performing Step (b35); after Step (b35) is performed, when the received instruction from the remote control is an English selection instruction sent by an arrow button of the remote control, performing Step (b36); before Step (b33) is performed, when the received instruction from the remote control is an upper/lower case switch instruction sent by an arrow button of the remote control, performing Step (b37); when a return instruction is received, performing Step (b38);
(b33) displaying a selection box, characters of the target string being arranged in the selection box according to a preset rule, and performing Step (b32);
(b35) inputting the target character to a pre-selection box, and according to a preset character input mapping table, displaying a candidate English character table corresponding to the target character or a combination of the target characters, and performing Step (b32);
(b36) moving the cursor to a target English character, and performing Step (c);
(b37) switching current upper case to lower case, or switching current lower case to upper case, and performing Step (b32); and
(b38) returning to a state of the previous step.

9. The method according to claim 8, wherein the input box is multiplexed to be the pre-selection box.

10. The method according to claim 1, further comprising:
(d1) in response to a position movement instruction sent by a button on the remote control, moving the cursor to a delete button, wherein the soft keyboard further comprises the delete button; and
(d2) in response to a delete character instruction sent by a button on the remote control, deleting a character already input into the input box.

11. A remote control configured to perform the method for inputting characters to a display device according to claim 1.

12. The remote control according to claim 11, being a shuttle remote control.

13. A non-transitory computer-readable medium storing instructions which, when executed by one or more processors, cause a remote control to perform a method for inputting characters to a display device, wherein the method comprises:
(a) in response to a character input request sent by a remote control, displaying an input box and a soft keyboard, wherein the soft keyboard comprises a plurality of preset single characters or strings, and wherein each string at most comprises four characters;
(b) in response to a position movement instruction sent by a button on the remote control, moving a cursor to a target character, wherein buttons on the remote control comprise arrow buttons and an Ok button; and
(c) in response to an input confirmation instruction sent by a button on the remote control, inputting the target character to the input box.
wherein the characters comprise English characters, pinyin characters, digit/symbol characters, five-stroke radical characters, and expression characters.

14. The non-transitory computer-readable medium according to claim 13, wherein Step (a) comprises:
(a1) according to the received character input instruction, displaying the input box and a default soft keyboard; and
(a2) according to an input method switch instruction, switching the default soft keyboard to a target soft keyboard.

15. The non-transitory computer-readable medium according to claim 14, wherein Step (a2) comprises:
(a21) receiving the input method switch instruction sent by a Menu button on the remote control; and
(a22) according to the received input method switch instruction, switching the default soft keyboard to the target soft keyboard;

16. The non-transitory computer-readable medium according to claim 14, wherein Step (a2) comprises:
(a23) in response to the position movement instruction sent by the button on the remote control, moving the cursor to an input method switch button, wherein the soft keyboard further comprises the input method switch button; and
(a24) in response to the input method switch instruction sent by a button on the remote control, switching the default soft keyboard to the target soft keyboard.

17. The non-transitory computer-readable medium according to claim 13, wherein when the target soft keyboard displays a plurality of preset digit/symbol characters, Step (b) comprises:
(b11) in response to a string selection instruction sent by an arrow button of the remote control, moving the cursor to a target string;
(b12) receiving the instruction from the remote control, and determining the type of the received instruction; when the received instruction from the remote control is a string selection confirmation instruction sent by the Ok button of the remote control, performing Step (b13); when the received instruction from the remote control is an input confirmation instruction sent by an arrow button of the remote control, performing Step (c); before Step (b13) is performed, when the received instruction from the remote control is a full/half width switch instruction sent by an arrow button of the remote control, performing Step (b16); when a return instruction is received, performing Step (b17);
(b13) displaying a selection box, characters of the target string being arranged in the selection box according to a preset rule, and performing Step (b12);
(b16) switching current half width to full width, or switching current full width to half width, and performing Step (b12); and
(b17) returning to a state of the previous step.

18. The non-transitory computer-readable medium according to claim 13, wherein when the target soft keyboard displays a plurality of preset pinyin characters, Step (b) comprises:
(b21) in response to a string selection instruction sent by an arrow button of the remote control, moving the cursor to a target string;
(b22) receiving the instruction from the remote control, and determining the type of the received instruction; when the received instruction from the remote control is a string selection confirmation instruction sent by the Ok button of the remote control, performing Step (b23); after Step (b23) is performed, when the received instruction from the remote control is a string selection instruction sent by an arrow button of the remote control, performing Step (b24); after Step b23 is performed, when the received instruction from the remote control is a Chinese character selection instruction sent by an arrow button of the remote control, performing Step (b25); when a return instruction is received, performing Step (b26);
(b23) according to a preset character input mapping table, displaying a candidate Chinese character table corresponding to the target string or a combination of the target strings, and performing Step (b22);
(b24) moving the cursor to the target string, and performing Step (b22);
(b25) moving the cursor to a target Chinese character, and performing Step c; and
(b26) returning to a state of the previous step.

19. The non-transitory computer-readable medium according to claim 13, wherein when the target soft keyboard displays a plurality of preset English characters, Step (b) comprises:
(b31) in response to a string selection instruction sent by an arrow button of the remote control, moving the cursor to a target string;
(b32) receiving the instruction from the remote control, and determining the type of the received instruction; when the received instruction from the remote control is a string selection confirmation instruction sent by the Ok button of the remote control, performing Step (b33); after Step (b33) is performed, when the received instruction from the remote control is a character confirmation instruction sent by the Ok button of the remote control, performing Step (b35); after Step (b35) is performed, when the received instruction from the remote control is an English selection instruction sent by an arrow button of the remote control, performing Step (b36); before Step (b33) is performed, when the received instruction from the remote control is an upper/lower case switch instruction sent by an arrow button of the remote control, performing Step (b37); when a return instruction is received, performing Step (b38);
(b33) displaying a selection box, characters of the target string being arranged in the selection box according to a preset rule, and performing Step (b32);
(b35) inputting the target character to a pre-selection box, and according to a preset character input mapping table, displaying a candidate English character table corresponding to the target character or a combination of the target characters, and performing Step (b32);
(b36) moving the cursor to a target English character, and performing Step (c);
(b37) switching current upper case to lower case, or switching current lower case to upper case, and performing Step (b32); and
(b38) returning to a state of the previous step.

20. The non-transitory computer-readable medium according to claim 13, wherein the method further comprises:
(d1) in response to a position movement instruction sent by a button on the remote control, moving the cursor to a delete button, wherein the soft keyboard further comprises the delete button; and
(d2) in response to a delete character instruction sent by a button on the remote control, deleting a character already input into the input box.
